(19) United States
(12) Patent Application Publication
(10) Pub. No.: US 2022/0112093 A1
(43) Pub. Date: Apr. 14, 2022

(54) CATHODE MATERIAL, PREPARATION METHOD THEREOF, AND ELECTROCHEMICAL DEVICE COMPRISING THE SAME

(71) Applicant: NINGDE AMPEREX TECHNOLOGY LIMITED, Ningde City, Fujian Province (CN)

(72) Inventors: Feng GU, Ningde City, Fujian Province (CN); Shiyang CHENG, Ningde City, Fujian Province (CN); Ye LANG, Ningde City, Fujian Province (CN); Leimin XU, Ningde City, Fujian Province (CN)

(21) Appl. No.: 17/265,136

(22) PCT Filed: Jan. 21, 2020
(86) PCT No.: PCT/CN2020/073595

§ 371 Date: Feb. 1, 2021

(51) Int. Cl. C01G 53/00; H01M 10/0525; C01G 51/00

(52) U.S. Cl. CPC C01G 53/50; C01P 2004/61; C01G 51/42; H01M 10/0525

(57) ABSTRACT

A cathode material includes a lithium composite oxide having lithium (Li) and at least one selected from cobalt (Co), nickel (Ni), manganese (Mn) or aluminum (Al); and a lithium-containing transition metal nitride. A transition metal in the lithium-containing transition metal nitride is at least one selected from cobalt (Co), nickel (Ni), or manganese (Mn). The cathode material provides excellent dynamic performance.

### CROSS REFERENCE TO RELATED APPLICATIONS

The present application is a National Stage application of PCT international application: PCT/CN2020/073595 filed on 21 Jan. 2020, the disclosure of which is hereby incorporated by reference in its entirety.

### BACKGROUND

### 1. Technical Field

The present application relates to the technical field of energy storage, and particularly to a cathode material, and an electrochemical device comprising the cathode material.

### 2. Description of the Related Art

With the popularization of consumer electronic products such as notebook computers, mobile phones, hand-held game consoles, tablet computers, mobile power supplies, and drones, the requirements for electrochemical devices (e.g., batteries) used therein are also getting much higher. For example, batteries are required to have not only light weight, but also to have high capacity and a long working life. Among the numerous batteries available, lithium-ion batteries have dominated the market due to their outstanding advantages, such as high energy density, high safety, low self-discharge, no memory effect, and long working life. The cathode material is one of the most critical components in lithium-ion batteries. At present, the development of cathode materials with high energy density, ultra-high rate and long cycle performance is the focus of research and development in the field of lithium-ion batteries.

### SUMMARY

An objective of the present application is to provide a modified cathode material and a preparation method thereof. By modifying the cathode material with a lithium-containing transition metal nitride described herein, not only the contact between the cathode surface and the electrolyte is lowered and the side reactions are reduced, but also the oxygen release from the surface is inhibited and good electron conductivity is provided. In addition, according to an embodiment of the present application, the lithium-containing transition metal nitride of the present application can provide lithium ion transmission, thereby providing excellent dynamic performance.

To achieve the above objective, in some embodiments, a cathode material is provided, which comprises: a lithium composite oxide comprising lithium (Li) and at least one selected from cobalt (Co), nickel (Ni), or manganese (Mn), and a lithium-containing transition metal nitride. The transition metal in the lithium-containing transition metal nitride is at least one selected from cobalt (Co), nickel (Ni), or manganese (Mn).

In some embodiments, the cathode material of the present application further includes a central portion comprising the lithium composite oxide, and a surface layer provided on at least a part of the central portion and comprising the lithium-containing transition metal nitride.

In some embodiments, the lithium-containing transition metal nitride is at least one selected from Liₓ₁Ni_{y1}N_{z1} (0<x1<8, 0<y1≤3, 0<z1≤4), Liₓ₂Co_{y2}N_{z2} (0<x2<24, 0<y2≤12, 0<z2≤6), or Liₓ₃Mn_{y3}N_{z3} (0<x3≤24, 0<y3≤3, 0<z3<11).

In some embodiments, the lithium composite oxide is at least one selected from compounds represented by chemical formulas 1, 2 or 3:

wherein, the compound of the chemical formula 1 is Li_{α}CoₐM1_{b}O_{2-c},

wherein M1 is at least one selected from nickel (Ni), manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and 0.8≤α≤1.2, 0.8≤a≤1, 0≤b≤0.2, and −0.1≤c≤0.2;

the compound of the chemical formula 2 is Li_{β}Ni_{d}CoₑM2_{f}O_{2-g},

wherein M2 is at least one selected from manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and 0.8≤β≤1.2, 0.3≤d≤0.98, 0.05≤e≤0.33, 0.01≤f≤0.33, and −0.1≤g≤0.2; and

the compound of the chemical formula 3 is Li_{y}Mn₂₋ₕM3ₕO₄₋ᵢ,

wherein M3 is at least one selected from cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W), and 0.8≤γ≤1.2, 0≤h<1.0, and −0.2≤i≤0.2.

In some embodiments, a content of the lithium-containing transition metal nitride is from 0.03% to 10.0% by weight based on a total weight of the cathode material.

In some embodiments, both the lithium composite oxide and the lithium-containing transition metal nitride in the cathode material comprise at least one of cobalt (Co), nickel (Ni), or manganese (Mn), and a chemical bond is formed between the lithium composite oxide and the lithium-containing transition metal nitride.

In some embodiments, the lithium-containing transition metal nitride has an average particle size of 0.1% to 30% of the average particle size of the lithium composite oxide. In some embodiments, the lithium-containing transition metal nitride has an average particle size of 20 to 3000 nm, and the lithium composite oxide has an average particle size of 3 to 20 μm.

The present application also provides an electrochemical device comprising the cathode material as described herein.

The present application also provides a method for preparing a cathode material, comprising:

formulating at least one of a nickel (Ni) source, a cobalt (Co) source, a manganese (Mn) source, and an aluminum (Al) source into a solution, and mixing and reacting the solution with a precipitant and a complexing agent to obtain a precursor;

mixing the precursor and a lithium (Li) source uniformly by grinding, and calcining to obtain a lithium composite oxide; and

mixing the lithium composite oxide with a lithium-containing transition metal nitride, and then calcining at 550° C. to 650° C. for 4-10 hours, to obtain a cathode material.

In an embodiment according to the present application, the solution further comprises a source of M element, and the M element is at least one selected from magnesium (Mg), calcium (Ca), strontium (Sr), barium (Ba), scandium (Sc), yttrium (Y), titanium (Ti), lanthanum (La), cerium (Ce), zirconium (Zr), titanium (Ti), vanadium (V), niobium (Nb), tantalum (Ta), molybdenum (Mo), tungsten (W), boron (B), gallium (Ga), indium (In), germanium (Ge), or antimony (Sb).

Additional aspects and advantages of the embodiments of the present application will be described or shown in the following description or interpreted by implementing the embodiments of the present application.

### BRIEF DESCRIPTION OF THE DRAWINGS

The following will briefly illustrate the accompanying drawings. Drawings necessary to describe the embodiments of the present application or the prior art will be briefly illustrated so as to facilitate the description of the embodiments of the present application. Obviously, the accompanying drawings described below only show some embodiments of the present application. For those skilled in the art, the drawings of other embodiments can still be obtained according to the structures illustrated in the drawings without any inventive effort.

FIG. 1 is a schematic diagram of a cathode material according to an embodiment of the present application, in which a lithium-containing transition metal nitride forms a surface layer on a part of the surface of the central portion.

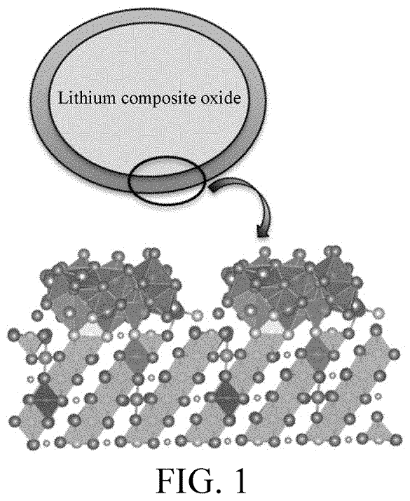

FIG. 2 shows the cycle performance test results of batteries prepared in Examples 1 and 2 of the present application.

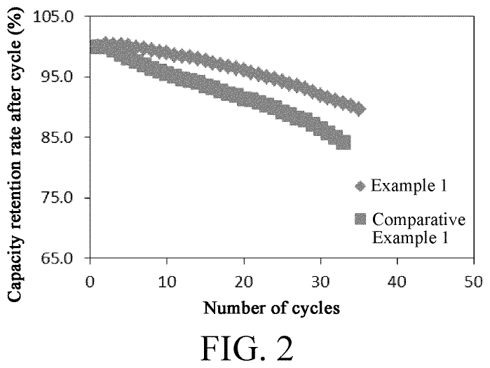

### DETAILED DESCRIPTION

The embodiments of the present application will be described in detail below. Throughout the specification, the same or similar components and components having the same or similar functions are denoted by similar reference numerals. The embodiments described herein with respect to the drawings are illustrative and graphical, and are used for providing a basic understanding of the present application. The embodiments of the present application should not be interpreted as limitations to the present application.

In the detailed description and the claims, a list of items connected by the term “one of” or similar terms may mean any of the listed items. For example, if items A and B are listed, then the phrase “one of A and B” means only A or only B. In another example, if items A, B, and C are listed, then the phrase “one of A, B and C” means only A; only B; or only C. The item A may include a single component or multiple components. The item B may include a single component or multiple components. The item C may include a single component or multiple components.

In the detailed description and the claims, a list of items connected by the term “at least one of” or similar terms may mean any combination of the listed items. For example, if items A and B are listed, then the phrase “at least one of A and B” means only A; only B; or A and B. In another example, if items A, B and C are listed, then the phrase “at least one of A, B and C” means only A; or only B; only C; A and B (excluding C); A and C (excluding B); B and C (excluding A); or all of A, B and C. The item A may include a single component or multiple components. The item B may include a single component or multiple components. The item C may include a single component or multiple components.

I. Cathode Material

A first aspect of the present application relates to a cathode material comprising a lithium composite oxide and a lithium-containing transition metal nitride, wherein the lithium composite oxide comprises (Li) and at least one of cobalt (Co), nickel (Ni), manganese (Mn), or aluminum (Al), and the transition metal in the lithium-containing transition metal nitride is at least one selected from cobalt (Co), nickel (Ni), or manganese (Mn).

In some embodiments according to the present application, the cathode material includes a central portion comprising the lithium composite oxide, and a surface layer provided on at least a part of the central portion and comprising the lithium-containing transition metal nitride. In some embodiments, the central portion of the cathode material is entirely covered by the surface layer.

In some embodiments according to the present application, the lithium composite oxide is at least one selected from the compounds represented by Chemical Formulas 1, 2 or 3:

LiₐCoₐM1_{b}O_{2-c} Formula 1

wherein M1 is at least one selected from nickel (Ni), manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and α, a, b and c are respectively in the following ranges: 0.8≤α≤1.2, 0.8≤a≤1, 0≤b≤0.2, and −0.1≤c≤0.2;

Li_{β}Ni_{d}CoₑM2_{f}O_{2-g} Formula 2

wherein M2 is at least one selected from manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and β, d, e, f and g are respectively in the following ranges: 0.8≤β≤1.2, 0.3≤d≤0.98, 0.05≤e≤0.33, 0.01≤f≤0.33, and −0.1≤g≤0.2; and

Li_{γ}Mn₂₋ₕM3ₕO₄₋ᵢ Formula 3

wherein M3 is at least one selected from cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W), and γ, h and i are respectively in the following ranges: 0.8≤γ≤1.2, 0≤h<1.0, and −0.2≤i≤0.2.

In some embodiments, the lithium composite oxide may be lithium cobalt oxide, lithium nickel cobalt manganese oxide, lithium manganese oxide or a Li-rich manganese-based material.

In some embodiments, the lithium composite oxide has an average particle size of 3 to 20 μm, for example, 3 μm, 5 μm, 10 μm, 11 μm, 12 μm, 13 μm, 14 μm, 15 μm, 20 μm, or any ranges therebetween.

In some embodiments, the lithium-containing transition metal nitride is at least one selected from: Liₓ₁Ni_{y1}N_{z1} (0<x1<8, 0<y1≤3, 0<z1≤4), Liₓ₂Co_{y2}N_{z2} (0<x2<24, 0<y2≤12, 0<z2≤6), and Liₓ₃Mn_{y3}N_{z3} (0<x3≤24, 0<y3≤3, 0<z3<11). In some embodiments, the lithium-containing transition metal nitride is one, two, three or more selected from Liₓ₁Ni_{y1}N_{z1} (0<x1<8, 0<y1≤3, 0<z1≤4), Liₓ₂Co_{y2}N_{z2} (0<x2<24, 0<y2≤12, 0<z2≤6), or Liₓ₃Mn_{y3}N_{z3} (0<x3≤24, 0<y3≤3, 0<z3<11).

In some embodiments, the lithium-containing transition metal nitride may form a lithium defect (where loss of lithium occurs in the crystal at a site where lithium should be present) during the synthesis process, resulting in non-integral stoichiometry ratios of x, y, and z.

In some embodiments, based on the total weight of the cathode material, a content in percentage by weight of the lithium-containing transition metal nitride is from 0.03% to 10.0%, for example, 0.03%, 0.05%, 0.1%, 0.2%, 0.3%, 0.4%, 0.5%, 1.0%, 2.0%, 3.0%, 4.0%, 5.0%, 6.0%, 7.0%, 8.0%, 9.0%, 10.0%, or any ranges therebetween. By setting the content in percentage by weight of the lithium-containing transition metal nitride in the above range, the overall energy density of the cathode material will not be reduced, and the performance of the material is substantially improved.

In some embodiments, a lithium-containing transition metal nitride has an average particle size of 20 to 3000 nm, for example, 20 nm, 50 nm, 100 nm, 150 nm, 200 nm, 250 nm, 500 nm, 1000 nm, 1500 nm, 3000 nm, or any ranges therebetween.

In some embodiments, a lithium-containing transition metal nitride has an average particle size that is from 0.1% to 30%, for example, 0.1%, 0.2%, 0.3%, 0.5%, 1%, 2%, 3%, 5%, 9%, 10%, 15%, 20%, 25%, 27%, 28%, 30%, or any ranges therebetween, of the average particle size of the lithium composite oxide. By setting the relationship between the particle sizes of the lithium-containing transition metal nitride and the lithium composite oxide, the lithium-containing transition metal nitride is allowed to be evenly coated on the material surface, and filled into the gaps between the particles to achieve the purpose of reducing the BET (specific surface area of the material). Moreover, the agglomeration, difficulty in exerting the coating effect, increased BET of the material and other problems caused by the small particle size of the lithium-containing transition metal nitride on the surface layer are avoided.

In some embodiments, both the lithium composite oxide and the lithium-containing transition metal nitride in the cathode material comprise at least one of cobalt (Co), nickel (Ni), or manganese (Mn), and a chemical bond is formed between the lithium composite oxide and the lithium-containing transition metal nitride. In some cases, the lithium composite oxide and the lithium-containing transition metal nitride contain at least one same element selected from cobalt (Co), nickel (Ni), and manganese (Mn). For example, both the lithium composite oxide and the lithium-containing transition metal nitride contain cobalt (Co), nickel (Ni), or manganese (Mn); or both comprise cobalt (Co) and nickel (Ni), cobalt (Co) and manganese (Mn), or nickel (Ni) and manganese (Mn); or both comprise cobalt (Co), nickel (Ni) and manganese (Mn). The lithium composite oxide has multiple crystal planes. The crystal plane index is one of the constants of crystals. The plane passing through any three nodes in the space lattice is called the crystal plane. The three integers obtained when the reciprocal ratios of the intercept coefficients of a crystal plane on the three crystal axes are converted into integer ratios are called the Miller index of the crystal plane. The exposed planes of the lithium composite oxide are mainly (003) plane and (104) plane. The (104) plane is the largest plane for lithium deintercalation and intercalation. Due to the special nature of surface exposure, the first layer of the plane comprises two-coordinated oxygen, three-coordinated oxygen, five-coordinated transition metal and lithium, and the inner layers all comprise three-coordinated oxygen, six-coordinated transition metal and lithium. The two-coordinated oxygen means that one oxygen atom is connected with two transition metal atoms, the three-coordinated oxygen means that one oxygen atom is connected with three transition metal atoms, and the five-coordinated transition metal means that one transition metal atom is connected with five oxygen atoms. In the case of deep delithiation, on the one hand, the surface transition metal is highly oxidative, and tends to undergo side reactions with the electrolyte, which leads to increased interfacial impedance or gas generation; and on the other hand, the surface two-coordinated oxygen has highly reactive oxygen and tends to release oxygen to undergo irreversible phase transition, hindering the transport of lithium ions.

The lithium-containing transition metal nitride (comprising at least one of cobalt (Co), nickel (Ni), and manganese (Mn)) according to the present application allows for lithium deintercalation and intercalation, and has the properties of both a covalent compound (N—O bond), and an ionic crystal (M-O bond, in which M represents one of nickel, cobalt, manganese). By providing the lithium-containing transition metal nitride on at least a part of the surface of the cathode material, the contact between the electrolyte and the cathode can be reduced on the one hand, and the lithium-containing transition metal nitride can be chemically bonded with cobalt (Co), nickel (Ni), and manganese (Mn) in the cathode material on the other hand, such that the linkage is stronger (the conventional coating is mostly physical contact), thereby inhibiting the surface phase transition. Moreover, the lithium-containing transition metal nitride itself has high electron conductivity (the N—O covalent bond contributes to the electron conductivity) and ionic conductivity (the lithium-containing transition metal nitride comprises lithium, and lithium ions have a lower migration barrier in the coating), and can improve the kinetic properties of the cathode material when coated on the surface of the cathode material.

II. Preparation Method of Cathode Material

A second aspect of the present application relates to a method for preparing the cathode material as described above. The preparation method is simple and easy to operate, and the reaction conditions are easy to control. It is suitable for use in industrial production and has broad commercial application prospects.

According to an embodiment of the present application, the method for preparing a cathode material according to the present application comprises:

(1) formulating at least one of a nickel (Ni) source, a cobalt (Co) source, a manganese (Mn) source, and an aluminum (Al) source into a solution, and mixing and reacting the solution with a precipitant and a complexing agent to obtain a precursor;

(2) mixing the precursor and a lithium (Li) source uniformly by grinding, and calcining to obtain a lithium composite oxide; and

(3) mixing the lithium composite oxide with a lithium-containing transition metal nitride, and then calcining at 550° C. to 650° C. for 4-10 hours, to obtain a cathode material.

The calcination in Step (2) is performed under an oxygen atmosphere at 700 to 800° C. for 10-12 hrs. The calcination in Step (3) is performed under a nitrogen atmosphere.

In an embodiment according to the present application, the solution in Step (1) further comprises a source of M element that is at least one selected from magnesium (Mg), calcium (Ca), strontium (Sr), barium (Ba), scandium (Sc), yttrium (Y), titanium (Ti), lanthanum (La), cerium (Ce), zirconium (Zr), titanium (Ti), vanadium (V), niobium (Nb), tantalum (Ta), molybdenum (Mo), tungsten (W), boron (B), gallium (Ga), indium (In), germanium (Ge), or antimony (Sb). The substance containing M element is a metal salt or an oxide of M element.

In the method, the nickel (Ni) source, cobalt (Co) source, manganese (Mn) source, and aluminum (Al) source may be in the form of a sulfate (e.g., NiSO₄, CoSO₄, MnSO₄, Al₂(SO₄)₃), nitrate or hydrochloride of nickel (Ni), cobalt (Co), manganese (Mn) and aluminum (Al). The precipitant is a solution comprising sodium ions, for example, NaOH, Na₂CO₃, NaHCO₃ or the like can be used. The lithium (Li) source includes, but is not limited to, LiOH or Li₂CO₃.

III. Electrochemical Device

A third aspect of the present application relates to an electrochemical device, which comprises a cathode, an anode, and a separator, wherein the cathode comprises the cathode material of the present application as described above, and the anode comprises an anode active material.

The electrochemical device of the present application includes any device in which an electrochemical reaction takes place, and specific examples include all kinds of primary batteries, secondary batteries, fuel cells, solar cells, or capacitors. In particular, the electrochemical device is a lithium secondary battery including a lithium metal secondary battery, a lithium ion secondary battery, a lithium polymer secondary battery or a lithium ion polymer secondary battery. In some embodiments, the electrochemical device is a lithium ion battery.

In the electrochemical device according to the third aspect of the present application, the specific type of the anode active material is not particularly limited, and can be selected as desired. Specifically, the anode active material is one or more selected from natural graphite, artificial graphite, mesocarbon microbeads (MCMB), hard carbon, soft carbon, silicon, a silicon-carbon composite, a lithium-tin (Li—Sn) alloy, a lithium-tin-oxygen (Li—Sn—O) alloy, tin (Sn), stannous oxide (SnO), stannic oxide (SnO₂), lithiated TiO₂—Li₄Ti₅O₁₂ having a spinel structure, metal lithium (Li) and a (Li—Al) alloy. The silicon-carbon composite means that at least 5 wt % of silicon is contained based on a weight of the silicon-carbon anode active material.

The separator includes at least one selected from the group consisting of polyethylene, polypropylene, polyethylene terephthalate, polyimide or aramid. For example, polyethylene includes at least one component selected from the group consisting of high-density polyethylene, low-density polyethylene, or ultrahigh molecular weight polyethylene. Particularly polyethylene and polypropylene have a good effect on preventing short circuits, and can improve the stability of the battery through the shutdown effect

The separator may further include a porous layer on the surface, and the porous layer is disposed on at least one surface of the separator. The porous layer comprises inorganic particles and a binder. The inorganic particles are selected from one of alumina (Al₂O₃), silica (SiO₂), magnesia (MgO), titania (TiO₂), hafnium dioxide (HfO₂), tin oxide (SnO₂), cerium dioxide (CeO₂), nickel oxide (NiO), zinc oxide (ZnO), calcium oxide (CaO), zirconia (ZrO₂), yttria (Y₂O₃), silicon carbide (SiC), boehmite, aluminum hydroxide, magnesium hydroxide, calcium hydroxide and barium sulfate, or a combination thereof. The binder is one selected from the group consisting of polyvinylidene fluoride, a copolymer of vinylidene fluoride-hexafluoropropylene, a polyamide, polyacrylonitrile, a polyacrylate ester, polyacrylic acid, a polyacrylate salt, carboxymethylcellulose sodium, polyvinylpyrrolidone, polyvinyl ether, polymethyl methacrylate, polytetrafluoroethylene, and polyhexafluoropropylene, or a combination thereof.

The porous layer on the surface of the separator can improve the heat resistance, oxidation resistance and infiltration ability of the separator by the electrolyte, and enhance the adhesion between the separator and the electrodes.

The electrochemical device further includes an electrolyte that may be one or more of a gel electrolyte, a solid electrolyte, and an electrolyte solution, where the electrolyte solution contains a lithium salt and a non-aqueous solvent.

The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt is LiPF₆, because it can provide high ionic conductivity and improve cycle characteristics.

The non-aqueous solvent may be a carbonate compound, a carboxylate compound, an ether compound, other organic solvents or a combination thereof.

The carbonate compound may be a chain carbonate compound, a cyclic carbonate compound, a fluorocarbonate compound or a combination thereof.

Examples of the chain carbonate compound include diethyl carbonate (DEC), dimethyl carbonate (DMC), dipropyl carbonate (DPC), methyl propyl carbonate (MPC), ethyl propyl carbonate (EPC), methyl ethyl carbonate (MEC) and a combination thereof. Examples of the cyclic carbonate compound include ethylene carbonate (EC), propylene carbonate (PC), butylene carbonate (BC), vinyl ethylene carbonate (VEC) and a combination thereof. Examples of the fluorocarbonate compound include fluoroethylene carbonate (FEC), 1,2-difluoroethylene carbonate, 1,1-difluoroethylene carbonate, 1,1,2-trifluoroethylene carbonate, 1,1, 2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate and combinations thereof.

Examples of the carboxylate compound include methyl acetate, ethyl acetate, n-propyl acetate, t-butyl acetate, methyl propionate, ethyl propionate, propyl propionate, γ-butyrolactone, decalactone, valerolactone, mevalonolactone, caprolactone, methyl formate and a combination thereof.

Examples of the ether compound include dibutyl ether, tetraethylene glycol dimethyl ether, diethylene glycol dimethyl ether, 1,2-dimethoxyethane, 1,2-diethoxyethane, ethoxymethoxyethane, 2-methyltetrahydrofuran, tetrahydrofuran and combinations thereof.

Examples of other organic solvents include dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, and a phosphate or a combination thereof.

IV. Use

The electrochemical device produced with the cathode material of the present application is suitable for use in electronic devices in various fields.

The use of the electrochemical device of the present application is not particularly limited and can be used for any purpose known in the art. In an embodiment, the electrochemical device according to the present application is applicable to, without limitation, notebook computers, pen-input computers, mobile computers, e-book players, portable phones, portable fax machines, portable copiers, portable printers, head-mounted stereo headphones, video recorders, LCD TVs, portable cleaners, portable CD players, minidisc players, transceivers, electronic notebooks, calculators, memory cards, portable recorders, radios, backup power sources, motors, vehicles, motorcycles, scooters, bicycles, lighting apparatuses, toys, game consoles, clocks, electric tools, flash lights, cameras, large batteries for household use, and lithium ion capacitors.

### EXAMPLES

Preparation Method

### Example 1

The cathode material was prepared following the steps below.

1) According to a molar ratio of Ni:Co:Mn=82:12:6 (according to the stoichiometric ratio of the lithium composite oxide), a mixed solution containing NiSO₄, CoSO₄, and MnSO₄ was formulated, which was mixed and reacted with a precipitant (a NaOH solution) and a complexing agent (aqueous ammonia). A nickel-cobalt-manganese precursor having an average particle size Dv50 of 11 μm was obtained by controlling the reaction time, the concentration and pH value of aqueous ammonia.

2) The nickel-cobalt-manganese precursor obtained in Step 1) and lithium hydroxide were mixed uniformly by grinding, and calcined under an oxygen atmosphere at 750° C. for 10 hrs to obtain a lithium nickel cobalt manganese oxide LiNi_{0.82}Co_{0.12}Mn_{0.6}O₂ (i.e., lithium composite oxide) agglomerate having a molar ratio of Ni:Co:Mn=82:12:6, and an average particle diameter Dv50 of 11 μm.

3) A certain amount of lithium nickel cobalt manganese oxide LiNi_{0.82}Co_{0.12}Mn_{0.6}O₂ was added to a high-speed mixer, and then the lithium-containing transition metal nitride Li₅Ni₃N₃ was added so that the content of Li₅Ni₃N₃ was 0.2% by weight based on the total weight of the cathode material, and stirred rapidly for 20 min.

4) The homogeneously mixed material in Step 3) was calcined in a furnace at 560° C. for 5 hrs under an oxygen atmosphere, and then crushed and sieved to obtain a cathode material comprising a lithium-containing transition metal nitride coating on the surface;

A lithium ion battery was prepared by using the cathode material prepared in the above steps. The preparation of the lithium ion battery was as follows.

The cathode material prepared in Step 4), the conductive agent of acetylene black, and the binder of polyvinylidene fluoride (PVDF) were mixed uniformly at a weight ratio of 90:5:5 by fully stirring in N-methylpyrrolidone (NMP) as a solvent system, coated onto an Al foil as a cathode current collector, and dried, to obtain a cathode which was cut into a 14 mm disc.

The anode active material of natural graphite, the conductive agent of acetylene black, the binder of styrene-butadiene rubber, and the thickener of carboxymethylcellulose sodium were mixed uniformly at a weight ratio of 96:1:1.5:1.5 by fully stirring in deionized water as a solvent system, and then applied to a Cu foil as an anode current collector, dried, cold pressed, and sliced to obtain an anode.

Polyvinylidene fluoride was dissolved in water and mechanically stirred to form a homogeneous slurry. The slurry was applied to both sides of a porous substrate (polyethylene) with a ceramic coating on both sides. After drying, a separator was formed.

A solution of the lithium salt LiPF₆ formulated in a non-aqueous organic solvent (ethylene carbonate (EC), diethyl carbonate (DEC), propylene carbonate (PC), propyl propionate (PP) and vinylene carbonate (VC))=20:30:20:28:2 by weight) at a weight ratio of 8:92 was used as the electrolyte for a lithium ion battery.

The cathode, the separator, and the anode were laminated in order such that the separator was located between the cathode and the anode as safety isolation. It was wound to obtain an electrode assembly. The electrode assembly was placed in an outer package, injected with an electrolyte, and encapsulated, to obtain a lithium-ion battery.

### Examples 2-20

Examples 2-5 differed from Example 1 in that a different lithium-containing transition metal nitride was used. Examples 6-10 differed from Example 1 in that the content in percentage by weight of the lithium-containing transition metal nitride was different. Examples 11-14 differed from Example 1 in that the particle size of the lithium-containing transition metal nitride was different. Examples 15-16 differed from Example 1 in that a different lithium composite oxide was used, wherein in Example 15, layered lithium cobalt oxide LiCoO₂ was used; and in Example 16, spinel lithium manganese oxide LiMn₂O₄ was used. Examples 17-19 differed from Example 1 in that the particle size of the lithium composite oxide was different. Example 20 differed from Example 1 in that the anode material was different. For details, see Table 1 below.

### Comparative Examples 1-6

The difference between Comparative Example 1 and Example 1, Comparative Example 2 and Example 15, and Comparative Example 3 and Example 16 was that the cathode material prepared in Examples 1-3 did not include a surface layer formed by the lithium-containing transition metal nitride. The difference between Comparative Example 4 and Example 1, Comparative Example 5 and Example 15, and Comparative Example 6 and Example 16 was that in Comparative Examples 4-6, Al₂O₃ was used in place of the lithium-containing transition metal nitride. For details, see Table 1 below.

The preparation parameters of the cathode material in the above examples and comparative examples are summarized in Table 1 below:

TABLE 1

| | | | | | | |
|---|---|---|---|---|---|---|
| | | | Average | | | |
| | | Content of | particle size | | | |
| | | lithium- | Dv50 (nm) | | Average | |
| | Lithium- | containing | of lithium- | | particle size | |
| | containing | transition | containing | | Dv50 (μm) | |
| | transition | metal | transition | Lithium | of lithium | |
| | metal | nitride | metal | composite | composite | Anode |
| Example | nitride | (wt %) | nitride | oxide | oxide | material |
| 1 | Li₅Ni₃N₃ | 0.2 | 200 | LiNi_{0.82}Co_{0.12}Mn_{0.6}O₂ | 11 | Natural |
| | | | | | | graphite |
| 2 | Li₇NiN₄ | 0.2 | 200 | LiNi_{0.82}Co_{0.12}Mn_{0.6}O₂ | 11 | Natural |
| | | | | | | graphite |
| 3 | Li_{2.54}Co_{0.46}N | 0.2 | 200 | LiNi_{0.82}Co_{0.12}Mn_{0.6}O₂ | 11 | Natural |
| | | | | | | graphite |
| 4 | Li₇MnN₄ | 0.2 | 200 | LiNi_{0.82}Co_{0.12}Mn_{0.6}O₂ | 11 | Natural |
| | | | | | | graphite |
| 5 | Li₂₄Mn₃N_{1.086} | 0.2 | 200 | LiNi_{0.82}Co_{0.12}Mn_{0.6}O₂ | 11 | Natural |
| | | | | | | graphite |
| 6 | Li₅Ni₃N₃ | 0.03 | 200 | LiNi_{0.82}Co_{0.12}Mn_{0.6}O₂ | 11 | Natural |
| | | | | | | graphite |
| 7 | Li₅Ni₃N₃ | 0.5 | 200 | LiNi_{0.82}Co_{0.12}Mn_{0.6}O₂ | 11 | Natural |
| | | | | | | graphite |
| 8 | Li₅Ni₃N₃ | 1 | 200 | LiNi_{0.82}Co_{0.12}Mn_{0.6}O₂ | 11 | Natural |
| | | | | | | graphite |
| 9 | Li₅Ni₃N₃ | 5 | 200 | LiNi_{0.82}Co_{0.12}Mn_{0.6}O₂ | 11 | Natural |
| | | | | | | graphite |
| 10 | Li₅Ni₃N₃ | 10 | 200 | LiNi_{0.82}Co_{0.12}Mn_{0.6}O₂ | 11 | Natural |
| | | | | | | graphite |
| 11 | Li₅Ni₃N₃ | 0.2 | 20 | LiNi_{0.82}Co_{0.12}Mn_{0.6}O₂ | 11 | Natural |
| | | | | | | graphite |
| 12 | Li₅Ni₃N₃ | 0.2 | 100 | LiNi_{0.82}Co_{0.12}Mn_{0.6}O₂ | 11 | Natural |
| | | | | | | graphite |
| 13 | Li₅Ni₃N₃ | 0.2 | 1000 | LiNi_{0.82}Co_{0.12}Mn_{0.6}O₂ | 11 | Natural |
| | | | | | | graphite |
| 14 | Li₅Ni₃N₃ | 0.2 | 3000 | LiNi_{0.82}Co_{0.12}Mn_{0.6}O₂ | 11 | Natural |
| | | | | | | graphite |
| 15 | Li₅Ni₃N₃ | 0.2 | 200 | Lithium cobalt oxide | 11 | Natural |
| | | | | (LiCoO₂) | | graphite |
| 16 | Li₅Ni₃N₃ | 0.2 | 200 | Lithium manganese | 11 | Natural |
| | | | | oxide(LiMn₂O₄) | | graphite |
| 17 | Li₅Ni₃N₃ | 0.2 | 200 | LiNi_{0.82}Co_{0.12}Mn_{0.6}O₂ | 3 | Natural |
| | | | | | | graphite |
| 18 | Li₅Ni₃N₃ | 0.2 | 200 | LiNi_{0.82}Co_{0.12}Mn_{0.6}O₂ | 5 | Natural |
| | | | | | | graphite |
| 19 | Li₅Ni₃N₃ | 0.2 | 200 | LiNi_{0.82}Co_{0.12}Mn_{0.6}O₂ | 20 | Natural |
| | | | | | | graphite |
| 20 | Li₅Ni₃N₃ | 0.2 | 200 | LiNi_{0.82}Co_{0.12}Mn_{0.6}O₂ | 11 | Artificial |
| | | | | | | graphite |
| Comparative | | | | | | |
| Example | | | | | | |
| 1 | / | / | / | LiNi_{0.82}Co_{0.12}Mn_{0.6}O₂ | 11 | Natural |
| | | | | | | graphite |
| 2 | / | / | / | LiCoO₂ | 11 | Natural |
| | | | | | | graphite |
| 3 | / | / | / | LiMn₂O₄ | 11 | Natural |
| | | | | | | graphite |
| 4 | Al₂O₃ | 0.2 | 200 | LiNi_{0.82}Co_{0.12}Mn_{0.6}O₂ | 11 | Natural |
| | | | | | | graphite |
| 5 | Al₂O₃ | 0.2 | 200 | LiCoO₂ | 11 | Natural |
| | | | | | | graphite |
| 6 | Al₂O₃ | 0.2 | 200 | LiMn₂O₄ | 11 | Natural |
| | | | | | | graphite |

Test Methods and Results of Lithium Ion Battery Performance

Test of Specific Discharge Capacity

The lithium-ion battery was charged to 4.3V at a rate of 0.1 C and then to 0.05 C at a constant voltage, and then discharged to 2.8V at a rate of 0.1 C to obtain the first charge capacity and first discharge capacity. Specific discharge capacity=first discharge capacity (mAh)/weight (g) of cathode material in cathode, first discharge efficiency=first discharge capacity (mAh)/first charge capacity (mAh)

Cycle Test

To speed up the cycle, the cut-off voltage was increased to 4.5V. The lithium-ion battery that has completed the specific discharge capacity test was charged to 4.5V at a rate of 0.5 C at 25° C. and then to 0.05 C at a constant voltage, and then discharged to 2.8V at a rate of 0.5 C. This process was cycled 50 times. Then, the capacity of the lithium-ion battery after 50 cycles was calculated. Capacity retention rate=50th discharge capacity (mAh)/first discharge capacity (mAh).

The performance parameter test results of the batteries prepared in the examples and comparative examples are provided in Table 2 below.

TABLE 2

| Examples | Specific discharge | First discharge | Capacity retention |
|---|---|---|---|
| | capacity (mAh/g) | efficiency (%) | rate (%) |
| 1 | 205.1 | 90.1 | 80.5 |
| 2 | 205.7 | 90.5 | 80.3 |
| 3 | 205.3 | 89.6 | 80.1 |
| 4 | 206.2 | 90.3 | 80.6 |
| 5 | 205.8 | 90.1 | 80.2 |
| 6 | 205.6 | 90.2 | 80.1 |
| 7 | 204.1 | 90.2 | 81.5 |
| 8 | 201.5 | 89.8 | 83.2 |
| 9 | 198.5 | 88.7 | 88.3 |
| 10 | 195.7 | 86.5 | 91.2 |
| 11 | 206.8 | 91.2 | 81.2 |
| 12 | 206.2 | 90.6 | 80.8 |
| 13 | 204.7 | 89.9 | 80.2 |
| 14 | 204.5 | 89.6 | 79.8 |
| 15 | 196.7 | 92.4 | 96.5 |
| 16 | 100.3 | 88.1 | 81.6 |
| 17 | 202.1 | 87.6 | 83.8 |
| 18 | 203.7 | 88.2 | 82.7 |
| 19 | 205.7 | 89.3 | 79.6 |
| 20 | 205.7 | 90.5 | 80.6 |
| Comparative | | | |
| Example | | | |
| 1 | 203.5 | 87.8 | 65.7 |
| 2 | 195.6 | 87.0 | 90.5 |
| 3 | 97.2 | 81.3 | 70.3 |
| 4 | 197.8 | 84.2 | 80.2 |
| 5 | 190.5 | 85.2 | 95.3 |
| 6 | 92.8 | 80.5 | 81.2 |

It can be seen from Table 2 that the cathode material of Comparative Examples 1-3 does not have a surface layer, and thus the interfacial stability of the cathode material is poor, causing a low capacity retention rate of the lithium ion battery. When the cathode material of Comparative Examples 4-6 is coated with alumina that is not chemically active, the cathode material has poor dynamic performance, low rate, and low conductivity, resulting in low specific discharge capacity and low first discharge efficiency of the lithium ion battery. Compared with Comparative Examples 1-6, the capacity retention rate, specific discharge capacity, and first discharge efficiency of the lithium ion battery are maintained at a higher level in Examples 1-20.

Specifically, it can be seen from the performance parameter test results of Examples 1-5 that when different types of lithium-containing transition metal nitrides are used, the cathode material according to the present application can provide excellent dynamic performance. It can be seen from the test results of Examples 1, and 6-10 that when a content of the lithium-containing transition metal nitride is in the range of 0.03 wt % to 1 wt %, a balanced improvement in battery performance is obtained. When a content exceeds 1 wt %, the capacity retention rate is improved significantly, while the specific discharge capacity and first discharge efficiency decline slightly. It can be seen from the test results of Examples 1, and 11-14 that when a particle size is in the range of 20-3000 nm, the performance of the battery is improved evenly. It can be seen from the test results of Examples 1, 15, and 16 that using different lithium composite oxides, the cathode material with a surface layer according to the present application can achieve comprehensive improvement of battery performance. It can be seen from the test results of Examples 1, and 17-19 that when a particle size is increased from 5 μm to 20 μm, the specific discharge capacity and first discharge efficiency of the battery are significantly improved. It can be seen from Examples 1 and 20 that the anode material can achieve the desired improvement effect using both natural graphite and artificial graphite.

Throughout the specification, references to “embodiment”, “part of embodiments”, “one embodiment”, “another example”, “example”, “specific example” or “part of examples” mean that at least one embodiment or example of the present application includes specific features, structures, materials or characteristics described in the embodiment or example. Thus, the descriptions appear throughout the specification, such as “in some embodiments,” “in an embodiment,” “in one embodiment,” “in another example,” “in an example,” “in a particular example” or “for example,” are not necessarily the same embodiment or example in the application. Furthermore, the specific features, structures, materials or characteristics in the descriptions can be combined in any suitable manner in one or more embodiments or examples.

Although illustrative embodiments have been shown and described, it should be understood by those skilled in the art that the above embodiments cannot be interpreted as limitations to the present application, and the embodiments can be changed, substituted and modified without departing from the spirit, principle and scope of the present application.

1. A cathode material, comprising:
a lithium composite oxide, comprising lithium (Li) and at least one selected from cobalt (Co), nickel (Ni), manganese (Mn), or aluminum (Al); and
a lithium-containing transition metal nitride, wherein a transition metal in the lithium-containing transition metal nitride is at least one selected from cobalt (Co), nickel (Ni) or manganese (Mn).

2. The cathode material according to claim 1, further comprising:
a central portion comprising the lithium composite oxide, and
a surface layer provided on at least a part of the central portion, and comprising the lithium-containing transition metal nitride.

3. The cathode material according to claim 1, wherein the lithium-containing transition metal nitride is at least one selected from Lix1Niy1Nz1 (0<x1<8, 0<y1≤3, 0<z1≤4), Lix2Coy2Nz2 (0<x2<24, 0<y2≤12, 0<z2≤6), or Liₓ₃Mny3Nz3 (0<x3≤24, 0<y3≤3, 0<z3<11).

4. The cathode material according to claim 1, wherein the lithium composite oxide is at least one selected from compounds represented by chemical formulas 1, 2 and 3:
wherein, the compound of the chemical formula 1 is LiαCoaM1bO2-c
wherein M1 is at least one selected from nickel (Ni), manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and 0.8≤α≤1.2, 0.8≤a≤1, 0≤b≤0.2, and −0.1≤c≤0.2;
the compound of the chemical formula 2 is LiβNidCoeM2fO2-g
wherein M2 is at least one selected from manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and 0.8≤β≤1.2, 0.3≤d≤0.98, 0.05≤e≤0.33, 0.01≤f≤0.33, and −0.1≤g≤0.2; and
the compound of the chemical formula 3 is LiγMn2-hM3hO4-i
wherein M3 is at least one selected from cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W), and 0.8≤γ≤1.2, 0≤h<1.0, and −0.2≤i≤0.2.

5. The cathode material according to claim 1, wherein a content of the lithium-containing transition metal nitride is from 0.03 to 10.0% by weight based on a total weight of the cathode material.

6. The cathode material according to claim 1, wherein both the lithium composite oxide and the lithium-containing transition metal nitride comprise at least one of cobalt (Co), nickel (Ni), or manganese (Mn), and a chemical bond is formed between the lithium composite oxide and the lithium-containing transition metal nitride.

7. The cathode material according to claim 1, wherein the lithium-containing transition metal nitride has an average particle size of 0.1% to 30% of the average particle size of the lithium composite oxide, an average particle size of the lithium-containing transition metal nitride is from 20 nm to 3000 nm, and an average particle size of the lithium composite oxide is from 3 μm to 20 μm.

8. An electrochemical device, comprising a cathode material, the cathode material comprising:
a lithium composite oxide, comprising lithium (Li) and at least one selected from cobalt (Co), nickel (Ni), manganese (Mn), or aluminum (Al); and
a lithium-containing transition metal nitride, wherein a transition metal in the lithium-containing transition metal nitride is at least one selected from cobalt (Co), nickel (Ni) or manganese (Mn).

9. A method for preparing a cathode material comprising:
formulating at least one of a nickel (Ni) source, a cobalt (Co) source, a manganese (Mn) source, and an aluminum (Al) source into a solution, and mixing and reacting the solution with a precipitant and a complexing agent to obtain a precursor;
mixing the precursor and a lithium (Li) source uniformly by grinding, and calcining to obtain a lithium composite oxide; and
mixing the lithium composite oxide with a lithium-containing transition metal nitride, and then calcining at 550 to 650° C. for 4-10 hrs, to obtain a cathode material.

10. The method according to claim 9, wherein the solution further comprises a source of M element, the M element is at least one selected from magnesium (Mg), calcium (Ca), strontium (Sr), barium (Ba), scandium (Sc), yttrium (Y), titanium (Ti), lanthanum (La), cerium (Ce), zirconium (Zr), titanium (Ti), vanadium (V), niobium (Nb), tantalum (Ta), molybdenum (Mo), tungsten (W), boron (B), gallium (Ga), indium (In), germanium (Ge), or antinomy (Sb).

11. The electrochemical device according to claim 8, wherein the cathode material further comprises:
a central portion comprising the lithium composite oxide, and
a surface layer provided on at least a part of the central portion, and comprising the lithium-containing transition metal nitride.

12. The electrochemical device according to claim 8, wherein the lithium-containing transition metal nitride is at least one selected from Liₓ₁Ni_{y1}N_{z1} (0<x1<8, 0<y1≤3, 0<z1≤4), Liₓ₂Co_{y2}N_{z2} (0<x2<24, 0<y2≤12, 0<z2≤6), or Liₓ₃Mn_{y3}N_{z3} (0<x3≤24, 0<y3≤3, 0<z3<11).

13. The electrochemical device according to claim 8, wherein the lithium composite oxide is at least one selected from compounds represented by chemical formulas 1, 2 or 3:
wherein, the compound of the chemical formula 1 is Li_{α}CoₐM1_{b}O_{2-c}
wherein M1 is at least one selected from nickel (Ni), manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and 0.8≤α≤1.2, 0.8≤a≤1, 0≤b≤0.2, and −0.1≤c≤0.2;
the compound of the chemical formula 2 is Li_{β}Ni_{d}CoₑM2_{f}O_{2-g},
wherein M2 is at least one selected from manganese (Mn), aluminum (Al), magnesium (Mg), boron (B), titanium (Ti), vanadium (V), chromium (Cr), iron (Fe), copper (Cu), zinc (Zn), molybdenum (Mo), tin (Sn), calcium (Ca), strontium (Sr), tungsten (W), yttrium (Y), lanthanum (La), zirconium (Zr), or silicon (Si), and 0.8≤β≤1.2, 0.3≤d≤0.98, 0.05≤e≤0.33, 0.01≤f≤0.33, and −0.1≤g≤0.2; and
the compound of the chemical formula 3 is Li_{γ}Mn₂₋ₕM3ₕO₄₋ᵢ,
wherein M3 is at least one selected from cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), or tungsten (W), and 0.8≤γ≤1.2, 0≤h<1.0, and −0.2≤i≤0.2.

14. The electrochemical device according to claim 8, wherein a content of the lithium-containing transition metal nitride is from 0.03% to 10.0% by weight based on a total weight of the cathode material.

15. The electrochemical device according to claim 8, wherein both the lithium composite oxide and the lithium-containing transition metal nitride comprise at least one of cobalt (Co), nickel (Ni), or manganese (Mn), and a chemical bond is formed between the lithium composite oxide and the lithium-containing transition metal nitride.

16. The electrochemical device according to claim 8, wherein the lithium-containing transition metal nitride has an average particle size of 0.1% to 30% of the average particle size of the lithium composite oxide, an average particle size of the lithium-containing transition metal nitride is from 20 nm to 3000 nm, and an average particle size of the lithium composite oxide is from 3 μm to 20 μm.
